(19) United States
(12) Patent Application Publication
(10) Pub. No.: US 2009/0032314 A1
(43) Pub. Date: Feb. 5, 2009

(54) Drive system for a machine

(75) Inventors: Justin D. Speichinger, Holly Springs, NC (US); Michael C. Layko, Apex, NC (US)

Correspondence Address: Caterpillar Inc.;Intellectual Property Dept., AH 9510, 100 N.E. Adams Street, PEORIA, IL, 61629-9510, US

(73) Assignee: Caterpillar S.A.R.L.

(21) Appl. No.: 11/888,972

(22) Filed: Aug. 3, 2007

(51) Int. Cl. B62D 11/04

(52) U.S. Cl. 180/6.5; 180/6.48; 477/1

(57) ABSTRACT

A machine is provided. The machine has a frame, an implement attached to a front end, a power source, a first and a second drive motor, a left front and rear axle, and a right front and rear axle. The first and second drive motors are powered by the power source, and each has an inner and an outer sprocket. The left rear axle is coupled to the inner sprocket of the first drive motor and rotatably coupled to the frame. The left front axle is coupled to the outer sprocket of the first drive motor and rotatably coupled to the frame. The right rear axle is coupled to the inner sprocket of the second drive motor and rotatably coupled to the frame. The right front axle is coupled to the outer sprocket of the second drive motor and rotatably coupled to the frame.

### TECHNICAL FIELD

This disclosure relates generally to a drive system for a machine, and more particularly, to a drive system for a skid steer loader.

### BACKGROUND

Skid steer loaders are highly maneuverable compact machines used in a variety of applications ranging from asphalt milling to earth moving, depending on the job and type of attachment being utilized. Skid steer loaders achieve this maneuverability through a differential transmission system, which allows an operator to separately control the speed of the wheels or track on each side of the machine. Typically, two drives are used to drive the skid steer loader—one drive for the left side and another for the right side. For wheeled machines, balancing the weight ratio between the front and rear axles during loaded and unloaded conditions enhances maneuverability. Balancing the weight ratio is accomplished, in part, by positioning the engine at the rear of the machine and the load or attachment being carried at the front.

When carrying a heavy load, a skid steer loader's combined center of gravity shifts to the front of the machine, resulting in an increased load and a higher normal force on the front axle. As a result, typical drive systems for skid steer loaders anticipate greater loads on the front axle than on the rear axle. An example of this can be seen in U.S. Pat. No. 4,131,225 to Bauer et al. and entitled “Method of Making a Vehicle Transmission Case” (“the '225 patent”). The '225 patent discloses a transmission having a pair of hydraulic motors that each have an output shaft having an inner and outer drive sprocket. A first endless chain connects the inner drive sprocket to the front wheel sprocket, while a second endless chain connects the outer drive sprocket to the rear wheel sprocket.

This configuration may work adequately for smaller machines. However, as a machine size increases, machines having drive systems as described in the '225 patent may be subjected to increased drive system failures. The present disclosure is directed to overcome one or more of the problems as set forth above.

### SUMMARY OF THE INVENTION

In one aspect of the present disclosure, a machine is provided. The machine has a frame, an implement attached to a front end, a power source, a first and a second drive motor, a left front and rear axle, and a right front and rear axle. The first and second drive motors are powered by the power source, and each of the first and second drive motors has an inner and an outer sprocket. The left rear axle is coupled to the inner sprocket of the first drive motor and rotatably coupled to the frame. The left front axle is coupled to the outer sprocket of the first drive motor and rotatably coupled to the frame. The right rear axle is coupled to the inner sprocket of the second drive motor and rotatably coupled to the frame. The right front axle is coupled to the outer sprocket of the second drive motor and rotatably coupled to the frame.

In another aspect of the present disclosure, a drive system for a skid steer loader having a frame and a power source, is provided. The drive system has a first and a second drive motor powered by the power source, and each of the first and second drive motors has an inner and an outer sprocket. The left rear axle is coupled to the inner sprocket of the first drive motor and rotatably coupled to the frame. The left front axle is coupled to the outer sprocket of the first drive motor and rotatably coupled to the frame. The right rear axle is coupled to the inner sprocket of the second drive motor and rotatably coupled to the frame. The right front axle is coupled to the outer sprocket of the second drive motor and rotatably coupled to the frame.

In a third aspect of the present disclosure, a method of providing a drive system for a machine having a power source is provided. The method includes the step of powering a first and a second drive motor by the power source, wherein each of the first and second drive motors has an inner and an outer sprocket. The method also includes the step of operably coupling a left rear axle to the inner sprocket of the first drive motor. The method also includes the step of operably coupling a left front axle to the outer sprocket of the first drive motor. The method also includes the step of operably coupling a right rear axle to the inner sprocket of the second drive motor. The method also includes the step of operably coupling a right front axle to the outer sprocket of the second drive motor.

### BRIEF DESCRIPTION OF THE DRAWINGS

FIG. 1 is a perspective view of a skid steer loader machine suitable for use with the present disclosure;

FIG. 2 is a top view of a drive system for the machine of FIG. 1; and

FIG. 3 is a perspective view of the drive system of FIG. 2.

### DETAILED DESCRIPTION

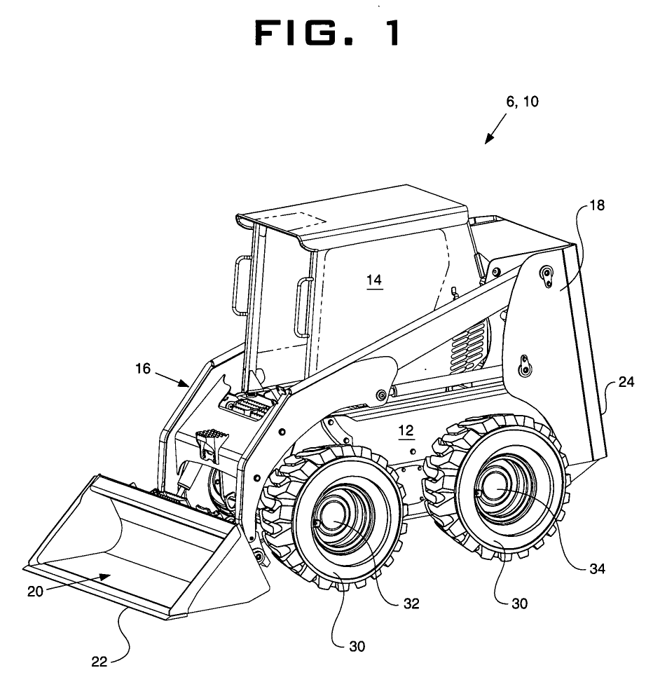

A machine 6 such as a skid steer loader 10 in accordance with the present disclosure is illustrated in FIG. 1. As shown, the skid steer loader 10 includes a body portion 12, an operator compartment 14, and a lift arm assembly 16. Front and rear wheels 30 are mounted to front and rear stub axles 32, 34 that extend from each side of the body portion 12 and are rotatably journalled in the body portion 12. The lift arm assembly 16 is pivotally mounted to laterally spaced side members or uprights 18 located at the rear end 24 of the body portion 12 and pivotally carries a work tool or implement 20 such as a bucket at the front end 22. It should be recognized that the skid steer loader 10 could also have a belt entrained around the front and rear wheels 30.

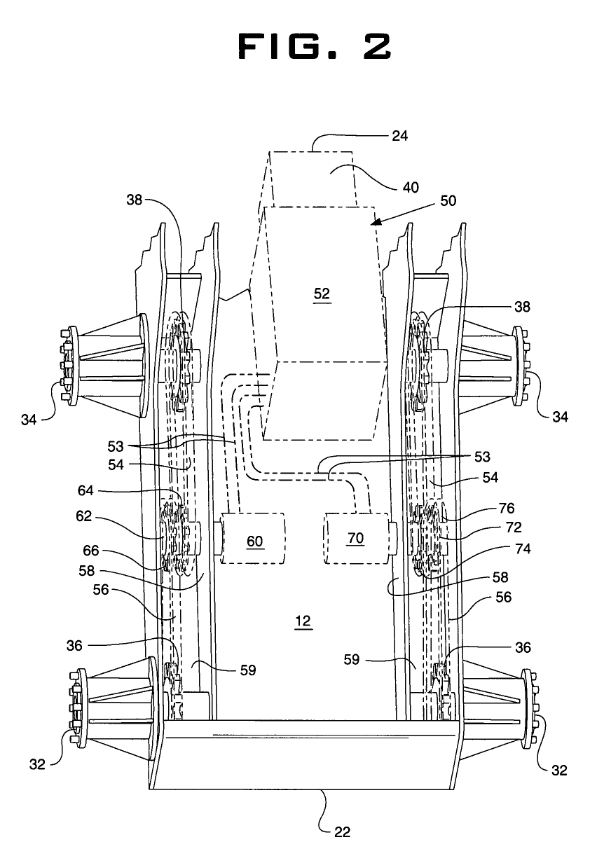

As seen in FIG. 2, the skid steer loader 10 includes an engine 40 that powers a drive system 50. The engine 40 is attached to the rear 24 of body portion 12. While the engine 40 is shown as a diesel engine, any other engine known in the art may also be used, such as a gasoline engine, a gaseous fuel driven engine, or any other engine known in the art. It is also contemplated that the engine 40 may alternately include another source of power such as a fuel cell, a power storage device, an electric or hydraulic motor, and/or another source of power known in the art. The engine 40 may be operatively connected to the drive system 50 by any suitable manner known in the art, such as, for example, gearing, a countershaft, and/or a belt.

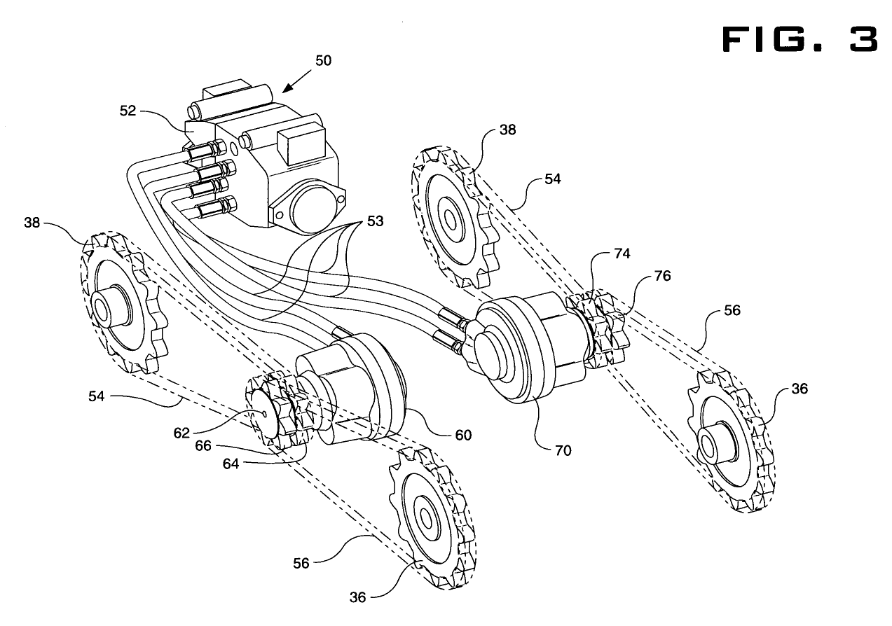

The drive system 50 shown in FIG. 2 is a dual-path hydrostatic transmission, although other transmissions known in the art may also be used, such as a mechanical or electrical variable-speed drive or gear-type transmissions. The drive system 50 includes a pair of variable displacement pumps 52, a left and a right drive motor 60, 70, a pair of front and rear endless drive chains 56, 54, and sprockets 64, 66, 74, 76. The variable displacement pumps 52 supply pressurized hydraulic fluid through supply lines 53 to drive the left and right drive motors 60, 70. The left and right drive motors 60, 70 are each mounted to one of a pair of mounting plates 58 located within the body portion 12. The left and right drive motors 60, 70 each have an output shaft 62, 72 that extends into one of a pair of chain boxes 59 formed in the body portion 12. As seen in FIG. 2, bearing packs (not shown), which are positioned within the drive motors 60, 70, provide cantilevered support for the output shafts 62, 72. The output shafts 62, 72 have inner sprockets 64, 74 and terminate in outer sprockets 66, 76, respectively. The inner sprockets 64, 74 are positioned adjacent the mounting plates 58. As seen in FIGS. 2-3, the drive motors 60, 70 supplies torque to the front and rear axles 32, 34 through the pairs of endless drive chains 54, 56. The first pair of endless drive chains 54 connects the inner sprockets 64, 74 to rear wheel sprockets 38 carried at the inner end of stub axles 34. The second pair of endless drive chains 56 connects the outer sprockets 66, 76 to front wheel sprockets 36 carried at the inner end of stub axles 32. In this configuration, inner sprockets 64 and 74 are located closer to the bearing pack of output shafts 62 and 72 than outer sprockets 66 and 76.

Referring back to FIG. 2, the chain boxes 59 house the pairs of first and second endless drive chains 54, 56, the inner and outer sprockets 64, 66, 74, 76 of the drive motors 60 and 70, and the front and rear wheel sprockets 36, 38. The chain boxes 59 may be sealed and filled with a lubricant such as oil.

### INDUSTRIAL APPLICABILITY

During operation of the machine 6, an operator (not shown) can independently control the speed and direction of the left and right wheels 30 to control the speed and direction of the machine 6. The engine 40 supplies power to the variable displacement pumps 52 of the drive system 50, which supply pressurized hydraulic fluid to the drive motors 60, 70 through supply lines 53. The drive motors 60,70 provide an output torque through output shafts 62, 72. The inner sprockets 64, 74 transmit the torque to rear wheel sprockets 38 through endless drive chains 54, while the outer sprockets 66, 76 transmit the torque to front wheel sprockets 36 through endless drive chains 56. This torque is transmitted from wheel sprockets 36, 38 to wheels 30, controlling the speed and direction of the machine 6.

This configuration of drive system 50 allows for the drive motors 60, 70 to be properly supported. The drive motors 60, 70 each have a bearing pack which must support the radial load generated by the chains that transfer the drive motor power to the axles 32, 34. The inner sprockets 64, 74, positioned closest to the bearing packs, are coupled to the rear wheel sprockets 38 because the rear wheels—not the front wheels, see the greatest loads.

The rear wheels and axles see greater loads than the front wheels and axles because as machine sizes increase, the combined center of gravity of the machine and load shifts backwards. As a result, a larger machine is less likely to have its rear wheels lifted off of the ground. Moreover, applications such as grading or back dragging, where the work tool is in contact with the ground and pressure is applied through the work tool, also raise the front of the machine and may lift the front tires off of the ground.

Further, when the machine is under certain load conditions, such as applications to pry, doze or lift material, the machine experiences high vertical loads at the work tool. These loads may compress the front tires of the machine so that the effective rolling radius of the front tires is smaller than the effective rolling radius of the rear tires. The tires having the largest effective rolling radius or the tires that remain in contact with the ground will drive the machine. Therefore, the components powering these tires experience the greatest loads. Because skid steer loaders are frequently equipped with solid or polyfill tires and are commonly used in rental applications involving relatively unskilled operators, relying on increased front tire pressures is not practical.

While the disclosure has been described with reference to details of the illustrated embodiments, these details are not intended to limit the scope of the disclosure as defined in the appended claims. For example, the drive motors have been described as hydraulic motors. However, it may be desired to substitute electric motors for the hydraulic motors described above. In such a case, the engine may be used to power a generator, which powers the motors. As described above, other power sources may be substituted for the engine, as well. Further, drive belts may be substituted for the endless chains. Other aspects, objects and advantages of this disclosure can be obtained from a study of the drawings, the disclosure, and the appended claims.

### LIST OF ELEMENTS

6. Machine
10. Skid steer loader
12. Body portion
14. Operator compartment
16. Lift arm assembly
18. Uprights
20. Implement
22. Front end
24. Rear end
30. Wheels
32. Front stub axles
34. Rear stub axles
36. Front wheel sprocket
38. Rear wheel sprocket
40. Engine
50. Drive system
52. Pumps
53. Supply lines
54. Rear or First endless chains
56. Front or Second endless chains
58. Mounting plate
59. Chain boxes
60. Right drive motor
62. Output shaft
64. Inner sprocket
66. Outer sprocket
70. Left drive motor
72. Output shaft
74. Inner sprocket
76. Outer sprocket

What is claimed is:

1. A machine having a frame and an implement attached to a front end of the machine, comprising:
a power source;
a first and a second drive motor powered by the power source, wherein each of the first and second drive motors has an inner and an outer sprocket;
a left rear axle coupled to the inner sprocket of the first drive motor and rotatably coupled to the frame;
a left front axle coupled to the outer sprocket of the first drive motor and rotatably coupled to the frame;
a right rear axle coupled to the inner sprocket of the second drive motor and rotatably coupled to the frame; and
a right front axle coupled to the outer sprocket of the second drive motor and rotatably coupled to the frame.

2. The machine of claim 1, wherein the inner and outer sprockets of each drive motor are positioned on a cantilevered shaft extending from the respective drive motor.

3. The machine of claim 1, wherein the power source is a variable displacement hydraulic pump.

4. The machine of claim 3 further comprising an engine, wherein the engine powers the hydraulic pump.

5. The machine of claim 1, wherein the machine is a skid steer loader.

6. The machine of claim 1, wherein the power source is a generator and the drive motors are electric motors.

7. The machine of claim 1 further comprising a lift arm assembly attached to a rear end of the machine and the implement.

8. A drive system for a skid steer loader having a frame and a power source, comprising:
a first and a second drive motor powered by the power source, wherein each of the first and second drive motors has an inner and an outer sprocket;
a left rear axle coupled to the inner sprocket of the first drive motor and rotatably coupled to the frame;
a left front axle coupled to the outer sprocket of the first drive motor and rotatably coupled to the frame;
a right rear axle coupled to the inner sprocket of the second drive motor and rotatably coupled to the frame; and
a right front axle coupled to the outer sprocket of the second drive motor and rotatably coupled to the frame.

9. The drive system of claim 8, wherein the inner and outer sprockets of each drive motor have a cantilevered support.

10. The drive system of claim 8, wherein the first and the second drive motors are one of a hydraulic motor and an electric motor.

11. The drive system of claim 8, wherein the first and the second drive motors are one of a hydraulic motor and an electric motor.

12. A method of providing a drive system for a machine having a power source, including the steps of:
powering a first and a second drive motor by the power source, wherein each of the first and second drive motors has an inner and an outer sprocket;
operably coupling a left rear axle to the inner sprocket of the first drive motor;
operably coupling a left front axle to the outer sprocket of the first drive motor;
operably coupling a right rear axle to the inner sprocket of the second drive motor; and
operably coupling a right front axle to the outer sprocket of the second drive motor.

13. The method of claim 12, wherein the machine is a skid steer loader.

14. The method of claim 12, further including:
providing a cantilevered support for the inner and outer sprocket of each drive motor.
